(19) United States
(12) Patent Application Publication
(10) Pub. No.: US 2012/0287084 A1
(43) Pub. Date: Nov. 15, 2012

(54) Wireless Communicational Optical Positioning Determining Device

(75) Inventor: Yu-Hsiang Cheng, Kaohsiung City (TW)

(73) Assignees: Tzay-Tein Guo, Taichung City (TW); Yu-Hsiang Cheng, Kaohsiung City (TW)

(21) Appl. No.: 13/349,564

(22) Filed: Jan. 13, 2012

(30) Foreign Application Priority Data
May 9, 2011 (TW) 100116185

(51) Int. Cl. G06F 3/042

(52) U.S. Cl. 345/175; 178/18.09

(57) ABSTRACT

A position determination device and process which makes use of wireless communication and optics media for touch control and employs a sensor unit for receiving signal provided at a bottom end of a touch pad. The particular identifiable signal source (modulated light) which is encoded and decoded based on optics transmission is detected, analyzed and identified, and is capable of using position calculating unit with relatively simple and easy calculation process to achieve a particular objective, and calculating and obtaining a particular position of the signal source, thereby complicated and costly processing unit for processing image in the prior arts can be avoided.

### BACKGROUND OF THE PRESENT INVENTION

1. Field of Invention

The present invention relates to a touch control device and its touch control method, and more particularly to a device and process of position determination for touch control which utilizes wireless communication and optics media.

2. Description of Related Arts

In general, touch control device which uses optical sensor type touch control mainly utilizes image processing technology which employs image sensor and lens in order to obtain an entire image. In theory, the image is divided into a number of units and the unit pixel of the image is determined by different current values caused by different levels of light intensity, which is then converted into different brightness level (grayness) corresponding to the light intensity such that later stage processing of brightness grading analysis and determination through software can be processed to obtain and construct the entire image, forming the basis for position interpretation process. Accordingly, a large amount of information has to be obtained through complete and continuous pixel arrays, which is then processed to obtain signal information by complicated and continuous calculation process. Thus, the cost of processing unit for position determination is greatly increased.

Nevertheless, when the image sensing process is only to distinguish the image position of a human's finger, a touch pen or other touch media within a large scale display, it is not necessary to make use of the complicate and continuous calculation process of high cost to complete the task. Therefore, it is necessary to simplify the information calculation process and hence the cost of processing for the conventional image sensing devices.

Conventional technology makes use of pixel arrays and the effect of light intensity on each pixel unit to obtain and determine a brightness (grayness) level corresponding to the light intensity of an image object. Common interference includes other light source in the work environment which is received and determined together with the image object, greatly increasing the possibility of determination failure or error for this kind of touch control device. On the other hand, the error level is increased when the pixel level is decreased.

In addition, patent documents such as U.S. Pat. Nos. 465,971 and 4,959,874 disclose the utilization of light as a medium (optical communication) as the basis for wireless communications in related arts. However, the disclosed technology do not involve optical communication serving as position determination for touch control in touch sensing device. The mere presence of optical communications does not provide any basis or benefits to utilizing optical communication technology in sensor for position determination. Accordingly, process of position determination for touch control is not realized and the cost of the processing unit is not lowered.

### SUMMARY OF THE PRESENT INVENTION

In view of the above problems, the inventor determines that an improved construction is required. Accordingly, the invention is to provide a wireless communicational optical position determination device, comprising:

a touch pad provided on a display defining a first side end at one side;

a light signal source provided on the first side end of the touch pad defining an emission direction from the light signal source towards the touch pad, wherein the light signal source is arranged for emitting a light beam and comprises an encoding device for encoding to provide a particular identifiable signal from the light beam;

a sensor unit for receiving signal provided below the touch pad comprising a plurality of light detecting units, each the light detecting unit is arranged for forming a signal for the light signal source through signal transmission and reflection from the light signal source in response to receiving a pressing status of the touch pad, wherein each the light detecting unit comprises a photoelectric element internally provided therein arranged for generating an electric signal corresponding to the signal through photoelectric effect and internal conversion and an identification unit for identifying the electric signal so as to determine to allow or block a passage of the electric signal through the identification unit; wherein the light detecting unit further comprises an amplifying element electrically connected to the photoelectric element of the light detecting unit arranged for receiving, decoding and analyzing signal source at a particular position; and

a position processing unit arranged for transforming the electric signal which is allowed to pass through the identification unit into a digital signal, comprising a scanning circuit with which the position processing unit is externally connected or is internally installed, and a time unit, wherein the position processing unit is electrically connected to the scanning circuit, wherein the digital signal is detected and read by the time unit which drives the process of sequential calculation and differentiation in order to obtain a particular identifiable information which is related to a particular position within arrays of the light detecting units and to obtain a useful information, which is an operation information necessary for and obtainable from a software for operation at a later stage, so as to process a position computation process for an object which is awaiting detection within a touch control work area of the touch pad.

Wireless or wireless communication refers to a communication method in which electromagnetic signal which has the feature of free communication in a define area (without using particular tangible wire, such as cable) is utilized to perform information exchange. Wireless optical or wireless communication with optical medium refers to wireless communication in which the frequency of the electromagnetic signal forms the basis and is classified into a plurality of frequency band, where the electromagnetic signal is defined as a medium for communication and transmission, the light media refers to the frequency band of this electromagnetic signal falling within the range of light (infrared˜ultralight, 10¹¹˜10¹⁶ Hz). In other words, wireless optical or wireless communication with optical medium refers to utilizing electromagnetic signal within this frequency band for communication and transmission. The present invention makes use of simple signal detection, the principle of single correlation in optical communications between the emission end and the receiving end, and signal calculation processing to determine a particular position (which is the position of an object awaiting detection). Therefore, the conventional method which involves complicated processing unit and utilizes a relative high cost for image processing is avoided.

Additional advantages and features of the invention will become apparent from the description which follows, and may be realized by means of the instrumentalities and combinations particular point out in the appended claims.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an illustration of a touch pad which is not at a pressing status according to a preferred embodiment of the present invention.

FIG. 2 is an illustration of a touch pad which is at a pressing status according to the above preferred embodiment of the present invention.

FIG. 3 is an illustration of a sensor unit for receiving signal according to the above preferred embodiment of the present invention.

FIG. 4 is an illustration of a light signal source according to the above preferred embodiment of the present invention.

FIG. 5 is a perspective illustration of a position determination device according to the above preferred embodiment of the present invention.

FIG. 6 is an exemplary illustration of frequency modulation of light signal source according to the above preferred embodiment of the present invention.

FIG. 7 is an exemplary illustration of amplitude modulation of light signal source according to the above preferred embodiment of the present invention.

FIG. 8A is an exemplary illustration of a coding process using frequency shift keying modulation of light signal source according to the above preferred embodiment of the present invention.

FIG. 8B is an exemplary illustration of a coding process using amplitude shift keying modulation of light signal source according to the above preferred embodiment of the present invention.

FIG. 8C is an exemplary illustration of a coding process using phase shift keying modulation of light signal source according to the above preferred embodiment of the present invention.

FIG. 9 is an exemplary illustration of a coding process of light signal source according to the above preferred embodiment of the present invention.

FIG. 10 is an illustration of a pre-processing stage of signal according to the above preferred embodiment of the present invention.

FIG. 11 is an illustration of a position determination of signal according to the above preferred embodiment of the present invention.

FIG. 12 is another exemplary illustration of a touch pad incorporated into a display and a light signal source according to the above preferred embodiment of the present invention.

### DETAILED DESCRIPTION OF THE PREFERRED EMBODIMENT

The detailed description, feature and embodiment of the present invention are provided as follows:

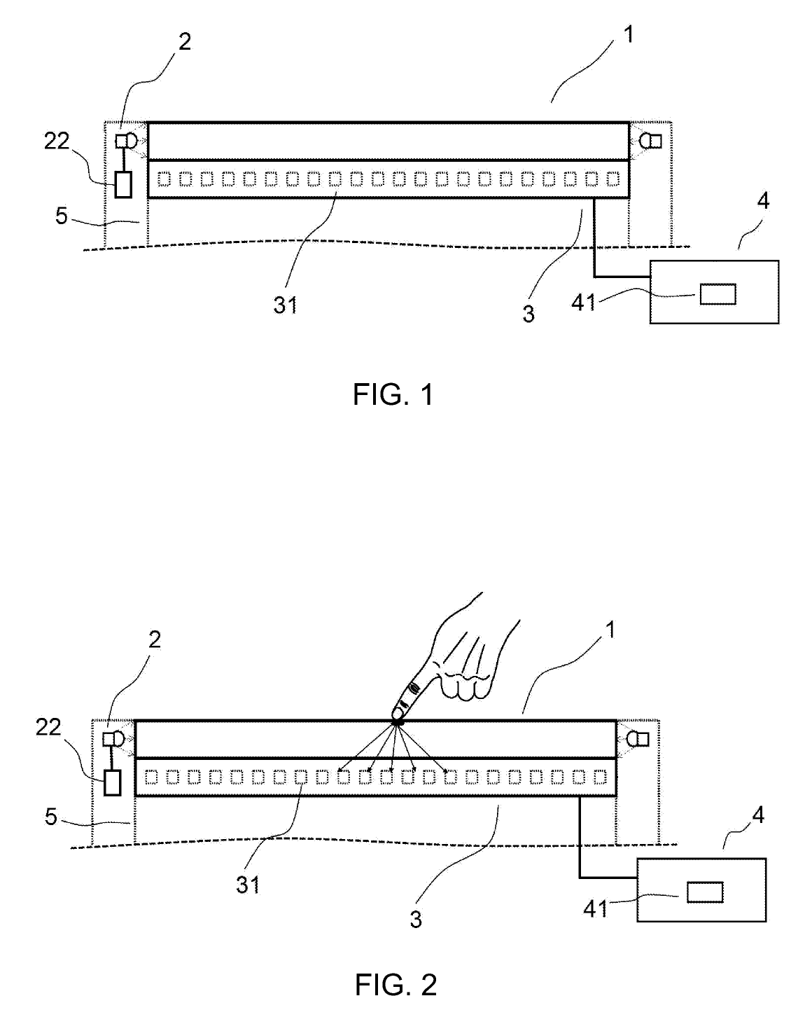

Referring to FIGS. 1 and 5 of the drawings, a wireless optical position determination device for touch control according to a preferred embodiment of the present invention includes a pressure sensitive touch pad 1 and a light signal source 2.

As shown in FIG. 12 of the drawings, the touch pad 1 can be arranged on a display unit 5.

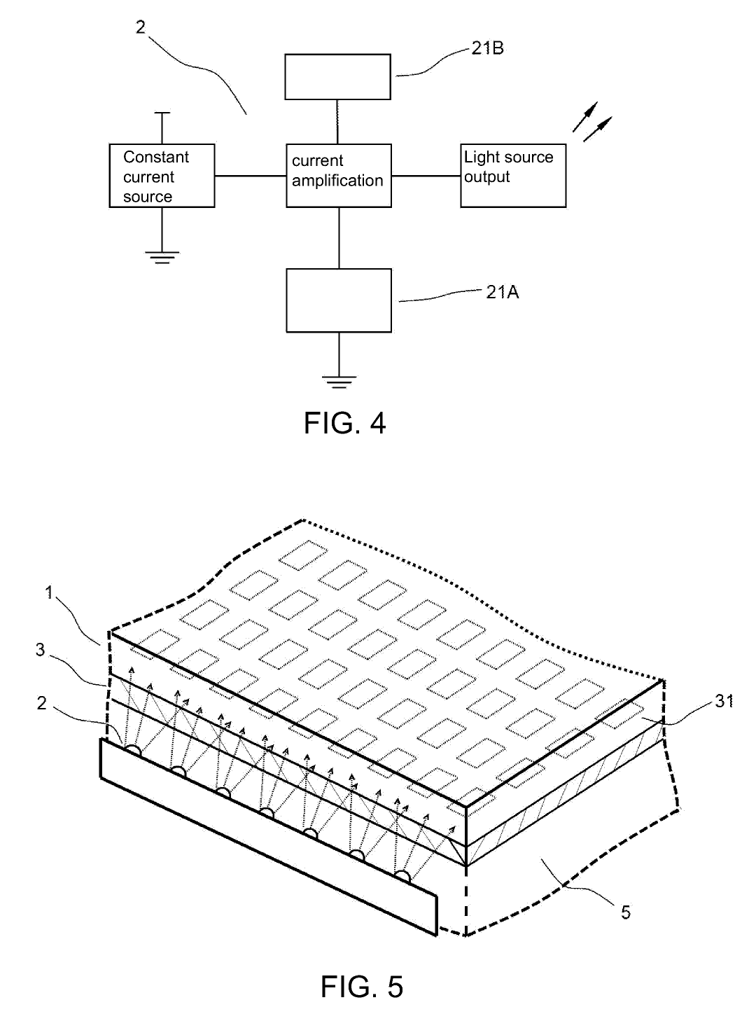

The light signal source 2 is illustrated in FIG. 4 of the drawing. In particular, the light signal source 2 is provided at a position which is on one side of the pressure sensitive touch pad 1 defining a first side of the pressure sensitive touch pad 1, wherein the position of the light signal source 2 can be broadly define to include a position from which the light signal source 2 is capable of reaching the pressure sensitive touch pad 1 and the light signal source 2 is facing towards the pressure sensitive touch pad 1, such as a position which is below one side of the pressure sensitive touch pad 1 as shown in FIG. 1 of the drawings, or a position which is below the pressure sensitive pad 1 as shown in FIG. 12 of the drawings, wherein the light signal source 2 is arranged to emit a light beam for wireless communication and comprises an encoding device 22 arranged for encoding a preset signal which is identifiable in response to the light beam from the light signal source 2. As shown in FIG. 4 of the drawings, the light signal source 2 defines an emission terminal and is arrange to emit an identifiable source signal (which is a modulated light source). The light signal source 2 comprises a modulation circuit 21A which is capable of generating a pulse current for identification, a light emitting member 21B provided at a rear end of the light signal source 2 for generating a corresponding identifiable source signal (which is a modulated light source) in response to the identifiable pulse current which is generated through the modulation circuit 21A. Preferably, the modulation circuit 21A is a coding circuit which employs an oscillator. The process of forming an identifiable source signal (which is the modulated light source) which is emitted from the light signal source 2 comprises the following steps:

(a) providing a constant current (voltage) to the circuit of the light signal source 2;

(b) generating a pulse current (an electric signal) for identification through an internal oscillation circuit (or coding device etc) of the light signal source 2; and

(c) triggering the light emitting member 21B (such as a light emitting diode LED) by the particular pulse current such that the light emitting member 21B emits the source signal (modulated light source) which is corresponding to the particular pulse current in response to the particular pulse current.

The modulation circuit 21A is a circuit of which the signal feature can be identified by a circuit assembly which includes a filter unit, a phase-lock loop unit and a decoder unit. Preferably, the modulation circuit 21A is a circuit assembly which includes an oscillator and a decoder. In particular, the light can carry information after modulation (which is: the signal source).

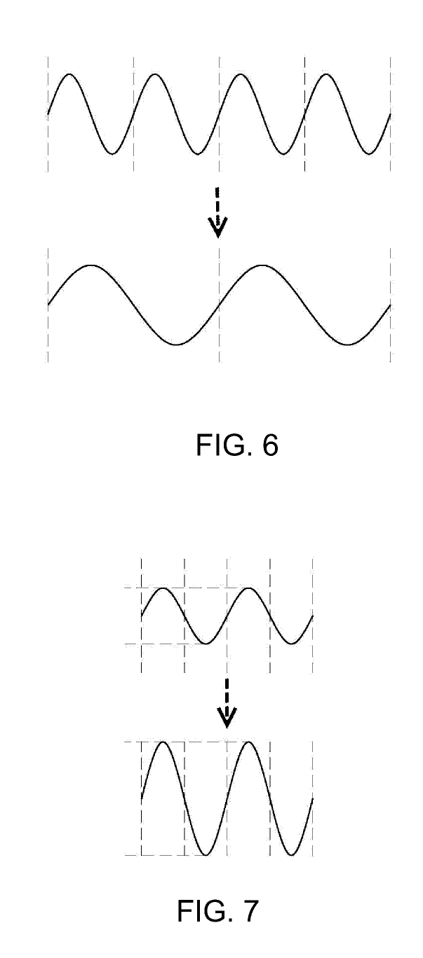

Referring to FIG. 6 of the drawings, a frequency modulation of light input according to the preferred embodiment of the present invention is illustrated. Referring to FIG. 7 of the drawings, an amplitude modulation of light input according to the preferred embodiment of the present invention is illustrated. A preset signal source is generated through a relative relationship between a “coding” at an emission terminal and a “decoding” at a receiving terminal.

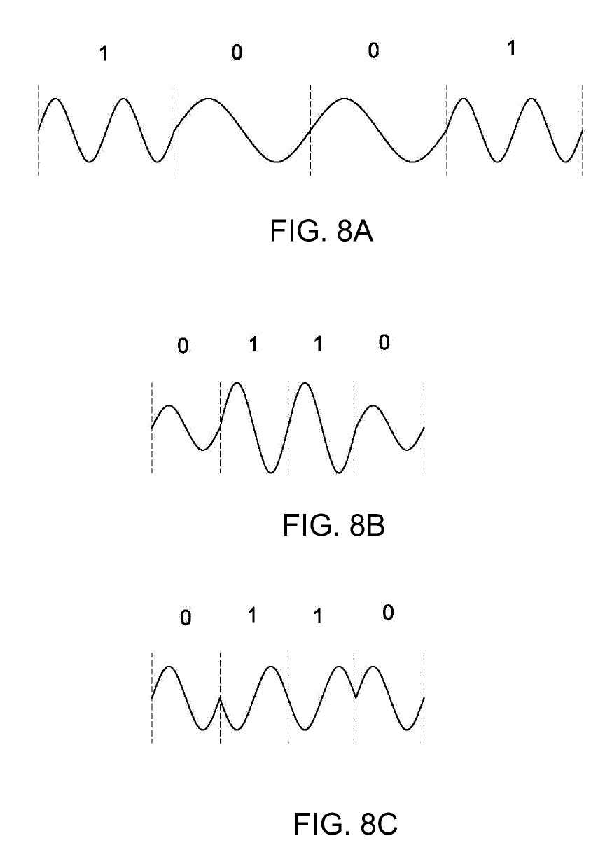

Coding is a process of transforming digital information into a signal which can be divided into analog coding and digital coding. A carrier (a waveform, usually a sine wave, which is modulated to carry data signal for signal transmission) passes through a process of modulation in frequency, phase, amplitude and etc. so as to adding a signal value is defined as analog coding. The process involves an assembly of a plurality of oscillators, diode and capacitor or phase-locked loop unit to achieve the coding. As shown in FIG. 8A of the drawings, a modulating process of frequency shift keying according to the preferred embodiment of the present invention is illustrated. As shown in FIG. 8B of the drawings, a modulating process of amplitude shift keying according to the preferred embodiment of the present invention is illustrated. As shown in FIG. 8C of the drawings, a modulating process of phase shift keying according to the preferred embodiment of the present invention is illustrated. Referring to FIG. 9 of the drawings, a digital coding according to the preferred embodiment of the present invention is illustrated in which pulse code modulation PCM is used to sample, quantify and coding information and to transform the information into binary coding in response to the amplitude of a particular signal such that a laser diode is controlled to an open/close status for transforming the 1 and 0 signal into pulsed light emission. Decoding is carried out through a receiver unit which makes use of a reversed process of coding to modulate the analog or digital signal into its original digital information.

The carrier which is used to carry information can be visible light or invisible light. During the operation, an object (such as a finger) is used to block the light to cause an reflection and the receiving terminal is used to receive this reflected light signal source (modulated light). The signal of the light signal source 2 is selected from a coding assembly which is formed by the frequency, phase and amplitude of light media. The identification unit 32 is a circuitry which determines the signal of the light signal source 2. In particular, the identification unit 32 is a decoding circuit assembly which selectively includes a filter unit, and a phase-locked loop unit etc.

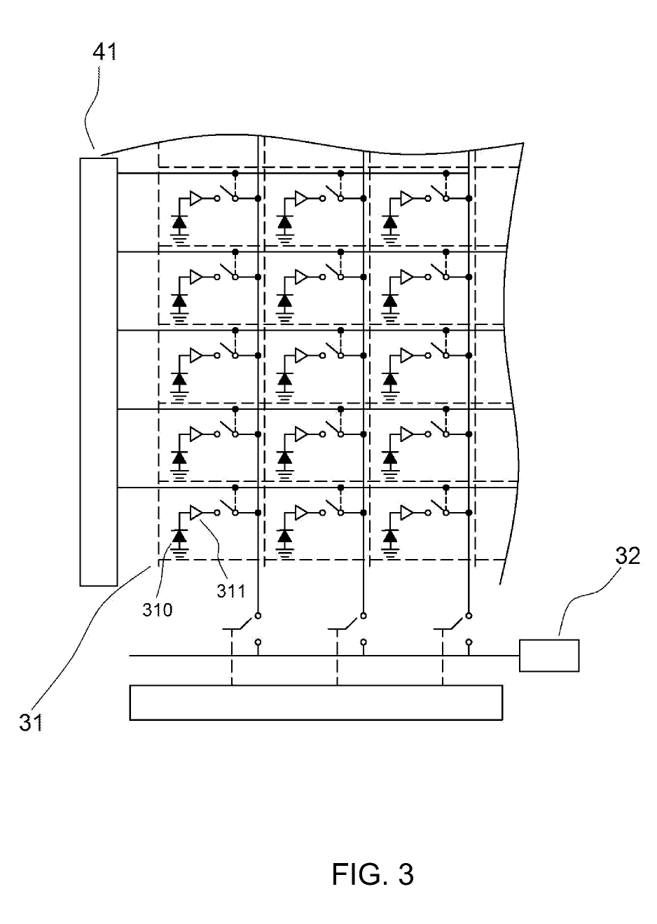

Referring to FIG. 3 of the drawings, a sensor unit 3 for receiving signal is illustrated.

The sensor unit 3 is positioned below the touch pad 1. Each of the sensor unit 3 comprises a light detecting unit 31 which is arranged to receive a pressing status of the touch pad. Referring to FIG. 2 of the drawings, a signal is formed from the signal of the light signal source which is the light signal source 2 after reflection. Each of the detecting unit 31 comprises an internal photoelectric element 310 (such as a photodiode and a phototransistor) which is arranged for providing photoelectric effect and conversion so as to generate a corresponding electric signal. Each of the light detecting unit 31 comprises an identification unit 32 for identifying the electric signal so as to determine if the electric signal is allowed to pass through the identification unit 32. According to the preferred embodiment of the present invention, the identification unit 32 is preferably an identification circuit. The photoelectric element 310 of the light detecting unit 31 is electrically connected to an amplifying element 311 which is arranged to receive, decode and analyze the particular position of the signal source (modulated light).

The position processing unit 4 converts the electric signal which passed through the identification unit 32 into a digital signal. The position processing unit 4 is connected to or is equipped with a scanning circuit 41 which is electrically connected to the light detecting unit 31 to detect and read the digital signal. The light detecting unit 31 defines an array and a particular position of a particular identifiable information at the array of the light detecting unit 31 can be obtained by sequential calculation and differentiation process driven by a time unit such that a useful information is obtained for providing computing information which is necessary for operation of software in the later stage. A position computation process is then processed for an object which is awaiting detection within a touch control work area.

A position determination process through wireless communication and optics media for touch control, comprising the steps of:

providing a touch pad 1, a light signal source 2 provided at a position which is on one side of the touch pad 1 such that a signal of the light signal source 2 after reflection is formed by signal transmission of the light signal source 2 in response to a pressing status of the touch pad 1, wherein the light signal source 2 defines an emission direction which faces a bottom end of the touch pad 1;

transmitting a particular identifiable signal of the light signal source 2;

providing a sensor unit 3 for receiving signal at the bottom end of the touch pad 1, wherein each of the sensor unit 3 comprises a light detecting unit 31 which is arranged to receive the pressing status of the touch pad for forming the signal of the light signal source 2 by signal transmission and reflection of the light signal source 2, and each of the detecting unit 31 comprises an internal photoelectric element 310 which is arranged for providing photoelectric effect and conversion so as to generate a corresponding electric signal, wherein each of the light detecting unit 31 comprises an identification unit 32 for identifying the electric signal so as to determine if the electric signal is allowed to pass through the identification unit 32;

providing a position processing unit 4 which is arranged to convert the electric signal which passes through the identification unit 32 into a digital signal, wherein the position processing unit 4 comprises or is connected to a scanning circuit 41 which is electrically connected to the light detecting unit 31; and

detecting and reading the digital signal, which is driven by a time unit for processing sequential calculation and differentiation to obtain a particular position of a particular identifiable information at an array of the light detecting unit 31, so as to obtain a useful information for providing computing information which is necessary for operation of software in the later stage, and processing a position computation process for an object which is awaiting detection within a touch control work area.

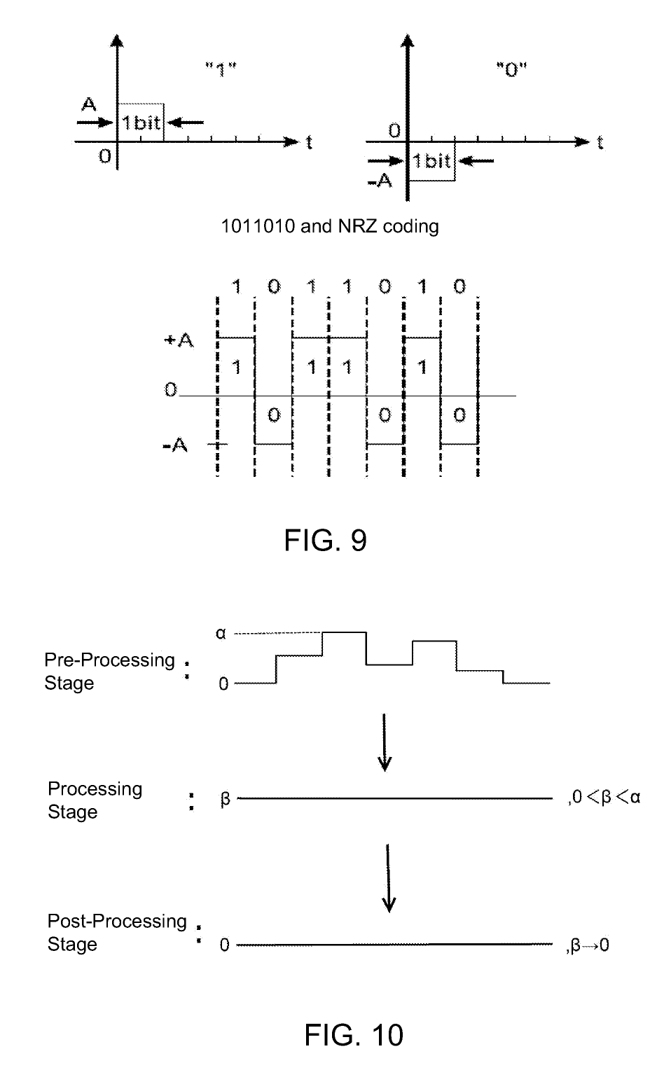

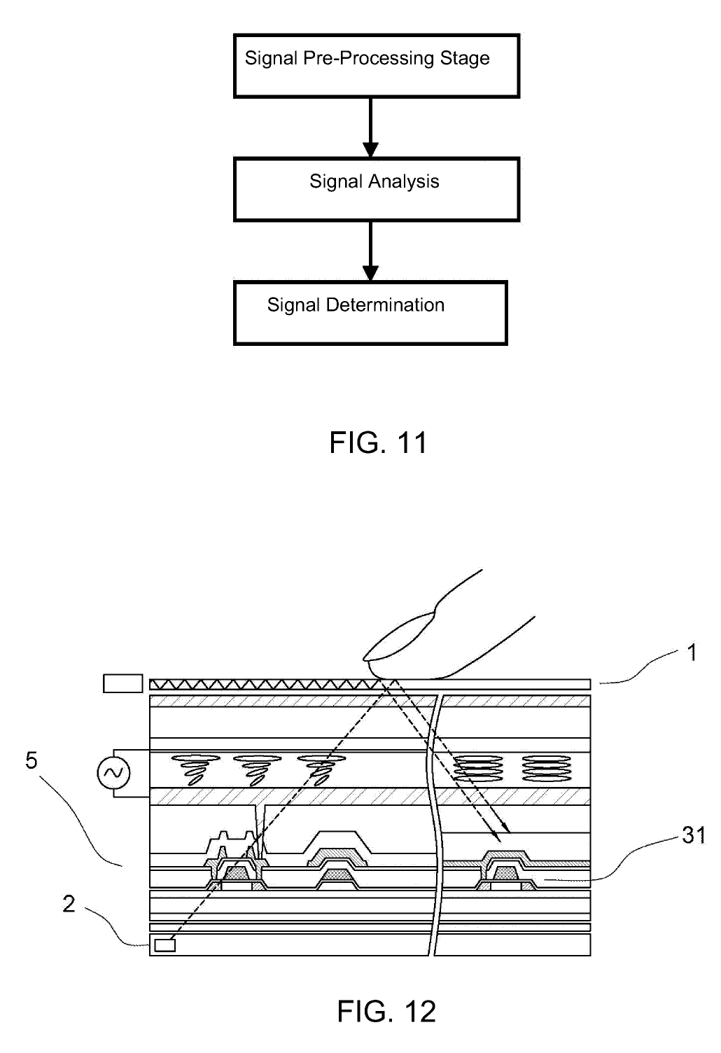

Referring to FIG. 10 of the drawings, the digital signal is driven by the time unit for processing sequential calculation to obtain an average value defining an average signal, such that an optimization process is provided to the signal which is based on optical transmission at the emitting end, wherein the position processing unit 4 has a preset signal strength threshold and defines a touch control signal value at which the average signal is identified to have a value greater than the signal strength threshold, thereby a touch control position is obtained through the touch control signal value. Referring to FIG. 11 of the drawings, the signal from the light signal source 2 and the sensor unit 3 for receiving signal is defined as pre-processing stage of the signal, at which the touch pad 1 is not under the pressing status and the light signal source 2 has an average signal defining a base value, which is set to zero.

Accordingly, the present invention clearly fulfils the utility requirement, is not published or in public use before the application, is not known to the public, has fulfils the non-obviousness requirement and hence is patentable.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wireless communicational optical position determination device, comprising:
a touch pad provided on a display defining a first side end at one side;
a light signal source provided on the first side end of said touch pad defining an emission direction from said light signal source towards said touch pad, wherein said light signal source is arranged for emitting a light beam which is applicable in wireless communication and comprises an encoding device for encoding to provide a particular identifiable signal from said light beam;
a sensor unit for receiving signal provided below said touch pad comprising a plurality of light detecting units, each said light detecting unit is arranged for forming a signal for said light signal source through signal transmission and reflection from said light signal source in response to receiving a pressing status of said touch pad, wherein each said light detecting unit comprises a photoelectric element internally provided therein arranged for generating an electric signal corresponding to the signal through photoelectric effect and internal conversion and an identification unit for identifying the electric signal so as to determine to allow or block a passage of the electric signal through said identification unit; wherein said light detecting unit further comprises an amplifying element electrically connected to said photoelectric element of said light detecting unit arranged for receiving, decoding and analyzing signal source at a particular position; and
a position processing unit arranged for transforming the electric signal which is allowed to pass through said identification unit into a digital signal, comprising a scanning circuit with which said position processing unit is externally connected or is internally installed, and a time unit, wherein said position processing unit is electrically connected to said scanning circuit, wherein the digital signal is detected and read by the time unit which drives the process of sequential calculation and differentiation in order to obtain a particular identifiable information which is related to a particular position within arrays of said light detecting units and to obtain a useful information, which is an operation information necessary for and obtainable from a software for operation at a later stage, so as to process a position computation process for an object which is awaiting detection within a touch control work area of said touch pad.

2. The position determination device, as recited in claim 1, wherein said identification unit is a identification circuit.

3. The position determination device, as recited in claim 1, wherein the signal of the light signal source is selected from a group consisting of frequency, phase, amplitude and coding of an optical medium, wherein said identification unit is a circuit which is capable of distinguishing the signal of said light signal source selecting from the group consisting of filter device, phase-locked loop unit and decoding unit.

4. The position determination device, as recited in claim 1, wherein said light signal source comprises a modulation circuit internally provided on said light signal source so as to generate a pulse current for a particular signal which is identifiable; and a light emitting member connected to a rear terminal of said circuit of said light signal source such that a particular identifiable pulse current is generated through said modulation circuit and a preset signal source corresponding to the particular identifiable pulse current is generated by said light emitting member.

5. The position determination device, as recited in claim 4, wherein said modulation circuit is a circuit formed by a group of decoding circuits which is capable of providing signal features for identification processing through a filter unit or a phase-locked loop unit.

6. The position determination device, as recited in claim 5, wherein said modulation circuit is a group of coding circuits selected from an oscillator, a diode, a capacitor and a phase-locked loop unit.

7. A position determination process through wireless communication and optics media for touch control, comprising the steps of: providing a signal through a touch pad and a light signal source, wherein said light signal source is provided at a position which is on one side of said touch pad and said signal is originated from said light signal source and is generated and reflected from said light signal source in response to a pressing status of said touch pad, wherein said light signal source defines an emission direction which is capable of facing a bottom end of said touch pad towards said touch pad; providing and transmitting a particular signal from said light signal source which is capable of being identifiable; providing a sensor unit for receiving signal at said bottom end of said touch pad and a light detecting unit for each said sensor unit, wherein each said light detecting unit is arranged for forming the signal of said light signal source through signal transmission and reflection from said light signal source in response to receiving a pressing status of said touch pad, wherein each said light detecting unit comprises a photoelectric element internally provided therein arranged for generating an electric signal corresponding to the signal through photoelectric effect and internal conversion, and an identification unit for identifying the electric signal so as to determine to allow or block a passage of the electric signal through said identification unit; providing a position processing unit arranged for transforming the electric signal which is allowed to pass through said identification unit into a digital signal, wherein said position processing unit comprises a scanning circuit with which said position processing unit is externally connected or is internally installed, wherein said scanning circuit is electrically connected to said position processing unit; and detecting and reading said digital signal, which is driven by a time unit for processing sequential calculation and differentiation to obtain a particular identifiable information which is related to a particular position within arrays of said light detecting units and to obtain a useful information, which is an operation information necessary for and obtainable from a software for operation at a later stage, so as to process a position computation process for an object which is awaiting detection within a touch control work area of said touch pad.

8. The position determination process, as recited in claim 7, wherein said digital signal is driven by said time unit for processing sequential calculation to obtain an average value for a particular position and defining an average signal for the particular position, wherein said position processing unit has a preset signal strength threshold and defines a touch control signal value at which the average signal is identified to have a value greater than the signal strength threshold, thereby a touch control position is obtained through the touch control signal value.

9. The position determination process, as recited in claim 8, further comprising the step of a pre-processing stage of signal from said light signal source and said sensor unit in which the average signal obtained and defined as a base value and is preset into zero when said touch pad is not under the pressing status.

10. The position determination process, as recited in claim 7, wherein said light signal source is positioned below said one side of said touch pad.

11. The position determination process, as recited in claim 7, wherein said light signal source is positioned below said touch pad.
